(19) United States
(12) Patent Application Publication
(10) Pub. No.: US 2014/0095806 A1
(43) Pub. Date: Apr. 3, 2014

(54) CONFIGURABLE SNOOP FILTER ARCHITECTURE

(71) Applicants: Carlos A. Flores Fajardo, Tlaquepaque JAL (MX); German Fabila Garcia, Zapopan, JAL (MX); Li Zhao, Beaverton, OR (US); Ravishankar Iyer, Portland, OR (US)

(72) Inventors: Carlos A. Flores Fajardo, Tlaquepaque JAL (MX); German Fabila Garcia, Zapopan, JAL (MX); Li Zhao, Beaverton, OR (US); Ravishankar Iyer, Portland, OR (US)

(21) Appl. No.: 13/631,935

(22) Filed: Sep. 29, 2012

(51) Int. Cl. G06F 12/08

(52) U.S. Cl. CPC G06F 12/0831
USPC 711/146

(57) ABSTRACT

Configurable snoop filters. A memory system is coupled with one or more processing cores. A coherent system fabric couples the memory system with the one or more processing cores. The coherent system fabric comprising at least a configurable snoop filter that is configured based on workload. The configurable snoop filter having a configurable snoop filter directory and a bloom filter. The configurable snoop filter and the bloom filter include runtime configuration parameters that are used to selectively limit snoop traffic.

### TECHNICAL FIELD

Embodiments of the invention relate to techniques for maintaining data coherency. More particularly, embodiments of the invention relate to techniques to reduce snoops used to maintain data coherency, which can result in a reduction in system power consumption.

### BACKGROUND

In a multi-core system (e.g., system on chip, SoC), power management can be a driving design consideration. One way of reducing power consumption is to reduce the operating frequency of one or more components of the system (e.g., a processing core). When all components of the system are running at high frequency, the power consumption rate is higher. Typically, the memory access path is the critical path wen operating at high frequency.

When conserving power by reducing operating frequency, the critical path can become the snoop path. Thus, managing the snoop path efficiently can be important in managing power consumption.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a multicore coherent system utilizing snoop filtering.

FIG. 2 is a block diagram of one embodiment of a snoop filter having a bloom filter.

FIG. 3a illustrates one embodiment of snoop filter entries for a line based snoop filter.

FIG. 3b illustrates one embodiment of snoop filter entries for a region based snoop filter.

FIG. 4a illustrates one embodiment of a line-based snoop filter lookup operation.

FIG. 4b illustrates one embodiment of a region-based snoop filter lookup operation.

FIG. 5a illustrates one embodiment of a line-based snoop filter update operation.

FIG. 5b illustrates one embodiment of a region-based snoop filter update operation.

FIG. 6 is a block diagram of one embodiment of a bloom filter.

FIG. 7 illustrates one embodiment of a lookup operation in a bloom filter.

FIG. 8 illustrates one embodiment of a bloom filter update operation.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Snoop filters can be utilized to avoid sending unnecessary snoop traffic and thereby remove snoop traffic from the critical path and reduce the amount of traffic and cache activity in the overall system, which can result in mitigation of performance impact and reduction of power consumption. Described herein are techniques for providing configurable snoop filtering that can be used to provide a more efficient technique for managing snoop traffic to result in improved performance and more efficient power consumption.

The techniques described herein can operate to reduce the amount of traffic generated by snoop requests in a coherent system in a flexible way to provide an improved performance/power consumption balance as compared to previous strategies. The techniques described herein can also reduce the design time of a coherent system by having configurable parameters in both run time and compile time.

Parameters such as, for example, memory size, write back policies, includes/non-inclusive modes of operation, line or regions base, can be configured to adapt filtering to the workloads and/or performance requirements of a coherent system. Bloom filters may also be sued to reduce the amount of memory utilization compared to conventional snoop filtering.

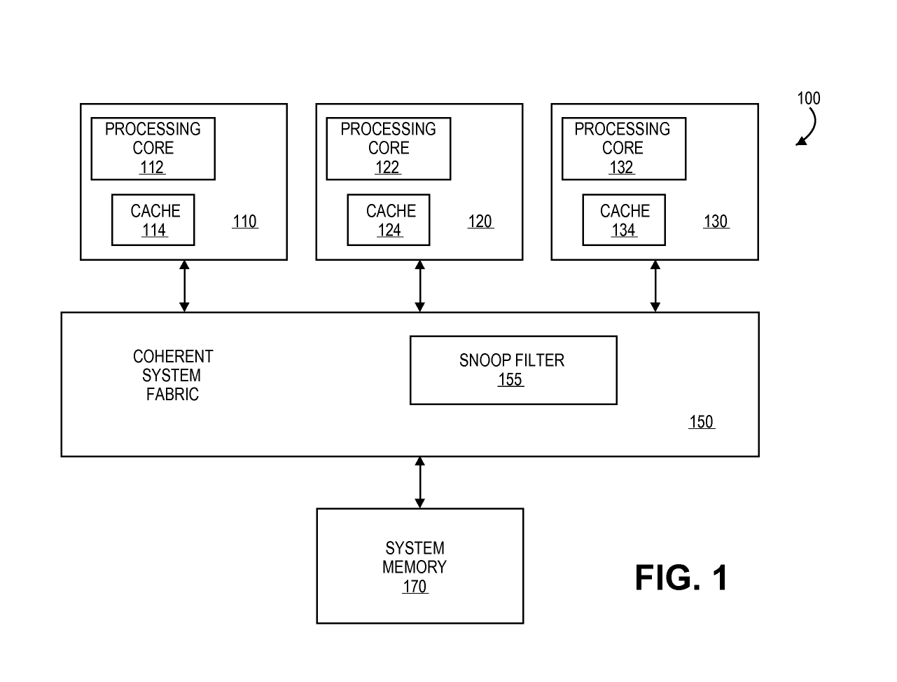

FIG. 1 is a block diagram of a multicore coherent system utilizing snoop filtering. Snooping is used to maintain coherency between caches in a system (e.g., SoC). For example, if a level two (L2) cache requests data, the connection/coherency fabric sends a snoop request to other L2 caches. The snoop filter operates to filter snoops requests to L2 caches that do not have a copy of the requested data.

The example of FIG. 1 illustrates system 100 having three system agents (110, 120 and 130); however, any number of system agents can be supported. The system agents include processing cores (112, 122 and 132) and cache memories (114, 124 and 134).

During normal operation, coherent system fabric 150 routes traffic between system agents. The traffic includes snoops in response to cache requests. As discussed above, snoop requests require power consumption, so a reduction in snoop requests can result in reduced power consumption.

Snoop filter 155 operates to intelligently reduce the number of snoops that are transmitted to the system agents. Various embodiments of snoop filters and operation of the snoop filters are provided in greater detail below. System memory 170 is coupled with the system agents via coherent system fabric 150.

Snooping maintains coherence between caches 114, 124 and 134. If one of cache memories 114, 124 or 134 requests data, coherent system fabric 150 operates to sent snoop requests to the other cache memories. Snoop filter 155 operates to filter the snoop requests so that cache memories that do not have a copy of the requested data do not receive a snoop request.

In one embodiment, snoop filter 155 keeps track of every request received by the coherent system. Snoop filter 155 uses this information to generate snoop requests to the caching agents efficiently. In one embodiment, snoop filter 155 can be configured to operate in one or more of the following five modes: 1) line-based inclusive snoop filtering (ISF); 2) line-based non-inclusive snoop filtering (NSF); 3) region based non-inclusive snoop filtering (RBNSF); 4) region-based non-inclusive snoop filtering with bloom filtering (RBNSF+BF); and 5) bloom filtering.

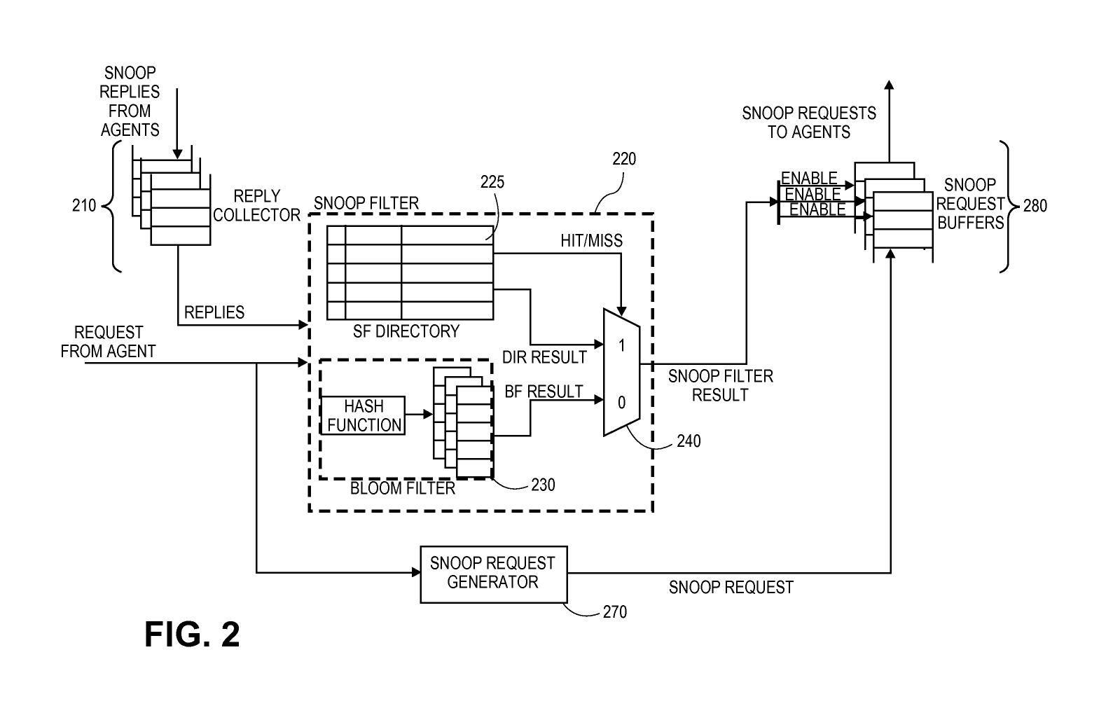

FIG. 2 is a block diagram of one embodiment of a snoop filter having a bloom filter. In one embodiment, the configurable snoop architecture includes two configurable components: the snoop filter directory and the bloom filter. In one embodiment, the snoop filter is configured based on the workload of the host device.

Snoop replies are stored in reply collector 210 prior to being provided to snoop filter 220. The snoop replies come from various system agents having cache memories. Snoop filter 220 also receives requests from agents. The requests are also provided to snoop request generator 270 to generate snoop requests to the other cache memories in the system.

In one embodiment, snoop request generator 270 generates a snoop request for all caches in the system other than the one generating the request. Snoop filter 220 operates to filter out the snoop requests to caches not having a copy of the requested data by tracking the requests with snoop filter (SF) directory 225 and determining which caches in the system have a copy of the requested data. This filtering can be further augmented by bloom filter 230, which is described in greater detail below.

In one embodiment, output from SF directory 225 and bloom filter 230 is provided to multiplexor 240. In one embodiment, selection by multiplexor 240 is controlled by a hit/miss signal from SF directory 225. The output signal from multiplexor 240 is used to enable one or more snoop requests staged in snoop request buffers 280. This operates to enable snoop requests to only the caches that have a copy of the requested data.

In one embodiment, SF directory 225 is an array organized in set-associative ways where each entry of the way may contain one or more valid bits (depending on configuration—either line or region based), agent status bits and a tag field. In one embodiment, a valid bit indicates whether the corresponding entry has valid information and the agent status bits are used to indicate if the cache line is present in the corresponding caching agent, and the tag field is use to save the tag of the cache line. In one embodiment, the agent status bits are configured as a bit mask for the various cache memories.

In one embodiment, snoop filter directory 225 can be configured at compile time as inclusive line-based, non-inclusive line based or non-inclusive region based.

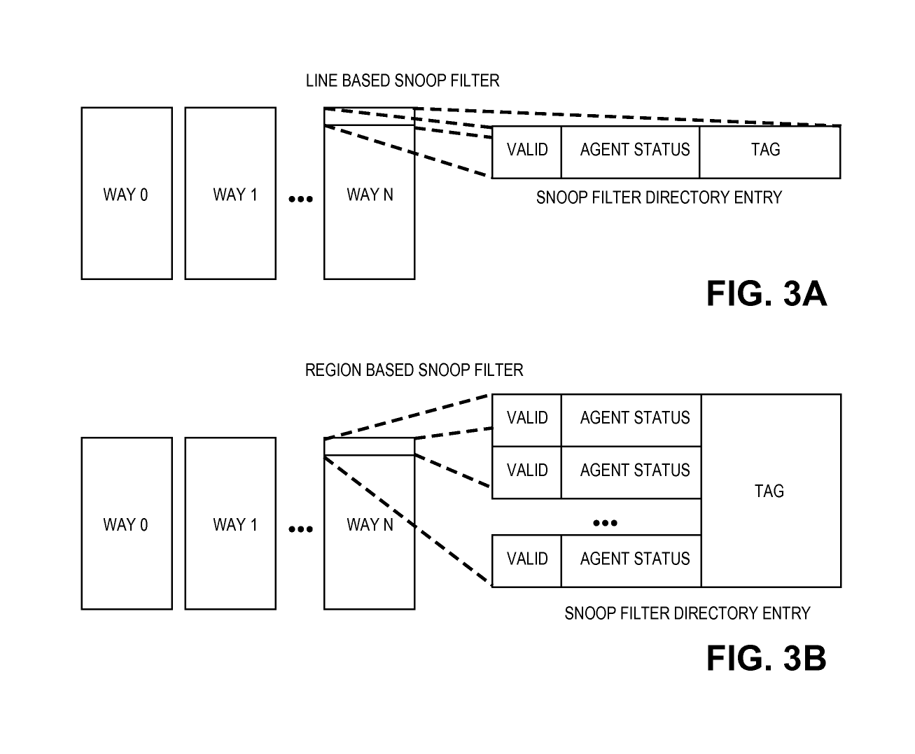

FIG. 3a illustrates one embodiment of snoop filter entries for a line based snoop filter. In line based mode, each SF directory entry contains a valid bit, agent status bits and a tag for the cache line. FIG. 3b illustrates one embodiment of snoop filter entries for a region based snoop filter. In region based mode, each SF directory entry contains information of all the cache lines within the region, thus each entry contains one valid bit per cache line, a set of agent status bits per cache line and only one tag per region.

The snoop filter directory provides at least two operations: lookup and update. During lookup, the request address is search in the directory, depending on the lookup result (i.e., hit or miss), the corresponding buffer enable bits are sent to the snoop request buffers (280 in FIG. 2). During the update, the SF directory (225 in FIG. 2) receives the request address, request opcode and the snoop replies from the reply collector (210 in FIG. 2) and updates the corresponding SF directory entry.

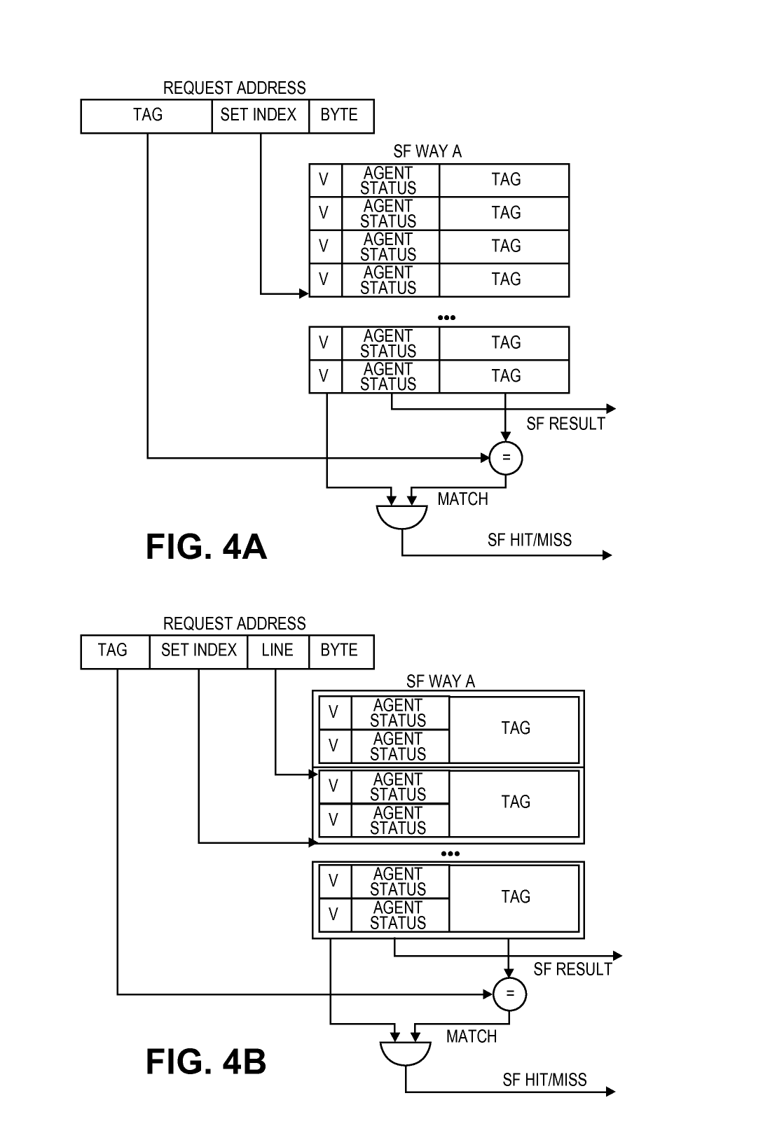

FIG. 4a illustrates one embodiment of a line-based snoop filter lookup operation. The snoop filter selects the way in which a hit occurs. If the result is a miss snoops are sent to all caches in non-inclusive mode, or the bloom filter result is used.

FIG. 4b illustrates one embodiment of a region-based snoop filter lookup operation. The snoop filter selects the way in which a hit occurs. If the result is a miss snoops are sent to all caches in non-inclusive mode, or the bloom filter result is used.

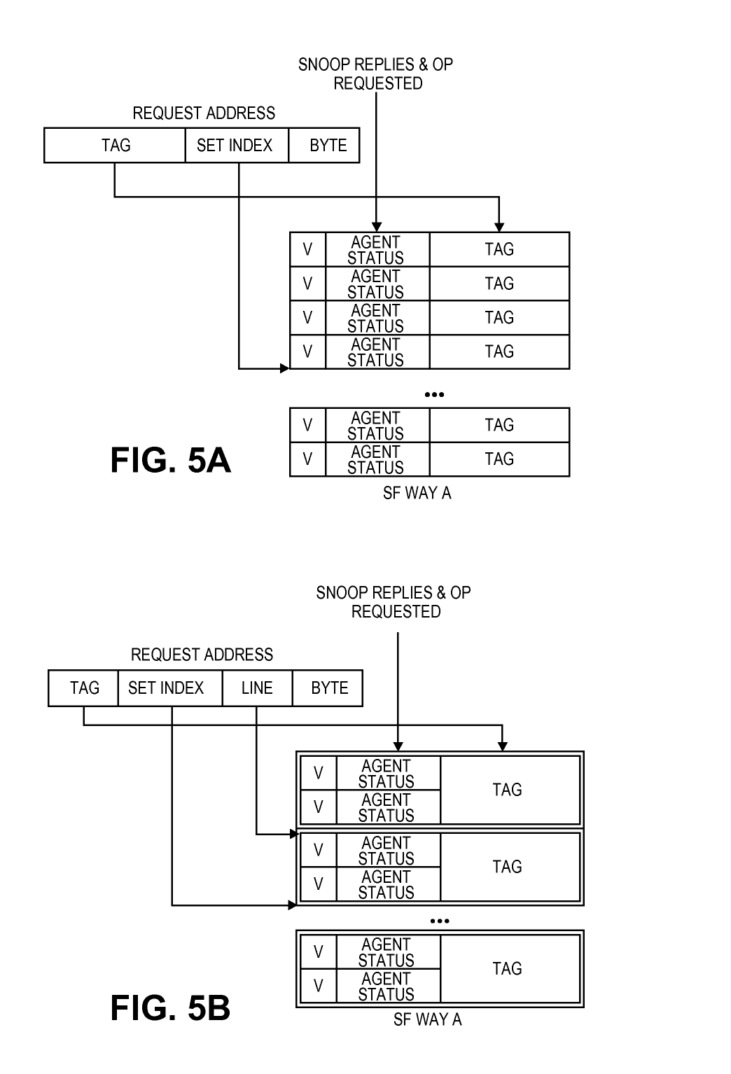

FIG. 5a illustrates one embodiment of a line-based snoop filter update operation. The snoop filter updates the way where the hit occurs. If the result is a miss the line in invalidated. If there are no valid lines the least recently used (LRU) way is updated.

FIG. 5b illustrates one embodiment of a region-based snoop filter update operation. The snoop filter updates the way where the hit occurs. If the result is a miss the line in invalidated. If there are no valid lines the least recently used (LRU) way is updated.

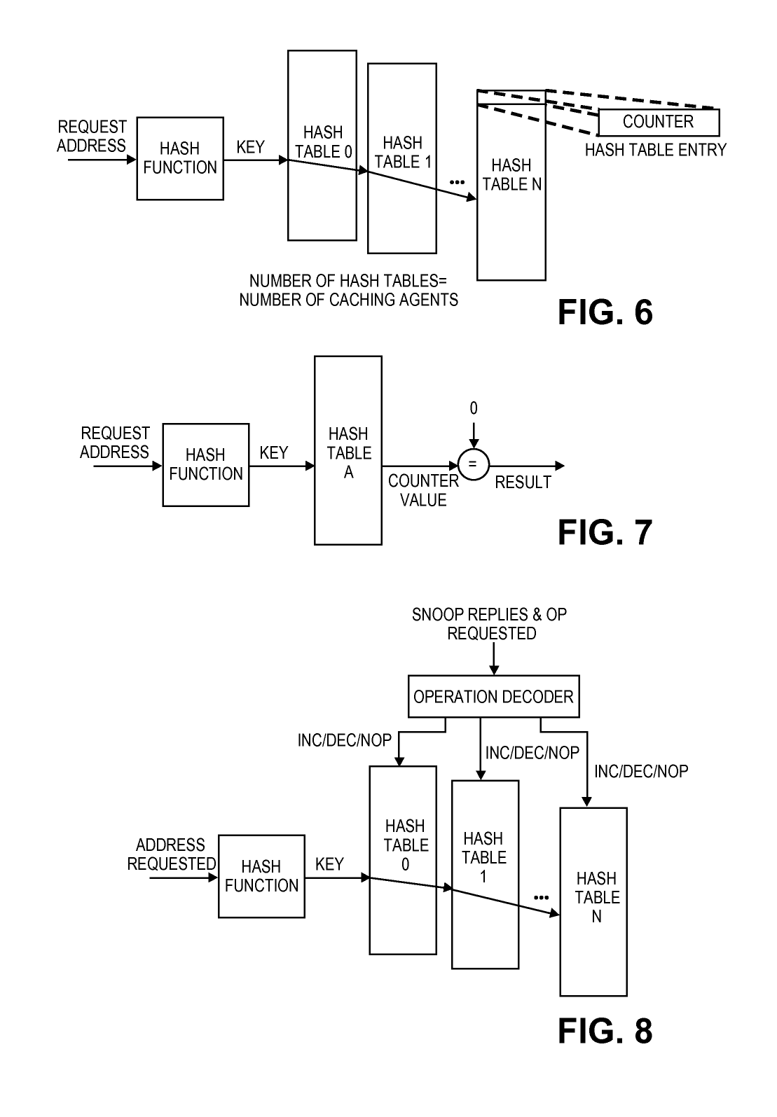

FIG. 6 is a block diagram of one embodiment of a bloom filter. In one embodiment, the bloom filter contains hash tables (e.g., one hashing table for each caching agent) where each entry of the hash tables is a counter. The bloom filter also contains a hash function that is used to generate keys based on the request address.

The counters are used to save statistical information about the number of times that a key address has been generated. Based on the statistical information, the bloom filter generates snoop requests. If the key generated by the requested address points to a counter that is zero, the corresponding caching agent does not have a copy of the cache line. If the key generated by the requested address points to a counter that is non-zero, the corresponding caching agent may have a copy of the cache line.

The bloom filter also provides lookup and update operations. FIG. 7 illustrates one embodiment of a lookup operation in a bloom filter. During lookup, the request address is passed through the hash function to generate a key and select the corresponding counter. Based on the value of the counter, the bloom filter generates a snoop request result. FIG. 8 illustrates one embodiment of a bloom filter update operation. In the update operation, counters are incremented or decremented based on the snoop replies, request opcodes and request address. For the region-based, non-inclusive+bloom filter mode of operation, the result generated by the bloom filter is only used if there is a miss in the SF directory.

The snoop filtering techniques and mechanisms described above (including the bloom filter) provide a configurability and flexibility that is not available in the prior art and that provides a more efficient snoop technique the ultimately results in a more resource-efficient system, which provides advantages such as lower power consumption.

The following parameters may be configured at compile/design time:
Address width: bit width of the request addresses
Cache line size: size in bytes of the cache lines
Number of caching agents: the number of caching agents to be connected to the coherent fabric
Depth of the snoop filter directory: number of entries per way of the snoop filter directory
Number of ways in the snoop filter directory
Region size: size of the region in terms of, for example, bytes
Hash table width: bit width of each entry of the hash tables, counter width
Hash table size: number of entries per hash table
Snoop filter directory enabled: used to prevent the snoop filter directory from being compiled
Bloom filter enabled: used to prevent the bloom filter from being compiled

The following parameters may be configured at run time:
Write back policy: various modes for a write back received by the snoop filter directory: 1) make invalid the corresponding snoop filter line; 2) keep the line valid but turn off the status agent bits; or 3) make the snoop filter line invalid, turn off the status agent bits and set the line as the LRU victim for the next eviction
Inclusive mode: used only in line based mode
Snoop filter directory enabled: enable/disable the snoop filter directory at run time
Bloom filter enabled: enable/disable the bloom filter at run time’

These examples are just one embodiment and other embodiments can have different combinations of parameters that can be configured during compile time, runtime or both based on different implementations.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
one or more processing cores;
a coherent system fabric to couple a memory system with the one or more processing cores, the coherent system fabric comprising at least a configurable snoop filter to be configured based on workload, the configurable snoop filter having bloom filter logic and storage to hold a configurable snoop filter directory,
control logic associated with the coherent system fabric, the control logic being capable to configure, during runtime, parameters associated with the bloom filter and the configurable snoop filter to selectively limit snoop traffic.

2. The apparatus of claim 1 wherein the snoop filter tracks each memory request within the coherent system fabric and generates snoop requests and the configurable snoop filter and bloom filter operating in one of: line-based inclusive snoop filtering, line-based non-inclusive snoop filtering, region based non-inclusive snoop filtering, region-based non-inclusive snoop filtering with bloom filtering, and bloom filtering.

3. The apparatus of claim 1 wherein the snoop filter directory comprises a memory organized in set-associative ways where each entry of the way contains one or more valid bits, agent status bits, and tag field.

4. The apparatus of claim 1 wherein the bloom filter comprise one hash table for each caching agent where each entry of the has tables is a counter, and the bloom filter further uses a hash function to generate keys based on the request address.

5. The apparatus of claim 4 wherein the counters are used to save statistical information about a number of times that a key address has been generated.

6. The apparatus of claim 5 wherein the bloom filter generates snoop requests based on the number of times that a key address has been generated.

7. The apparatus of claim 1 wherein the write back policy of the coherent system fabric is configurable at run time.

8. The apparatus of claim 1 wherein inclusive or non-inclusive mode is configurable at run time.

9. The apparatus of claim 1 wherein enabling/disabling of the snoop filter is configurable at run time.

10. The apparatus of claim 1 wherein enabling/disabling of the bloom filter is configurable at run time.

11. A system comprising:
a memory system comprising at least dynamic random access memory (DRAM) devices;
one or more processing cores;
a coherent system fabric to couple the memory system with the one or more processing cores, the coherent system fabric comprising at least a configurable snoop filter that is configured based on workload, the configurable snoop filter having a configurable snoop filter directory and a bloom filter, the configurable snoop filter and the bloom filter include runtime configuration parameters that are used to selectively limit snoop traffic.

12. The system of claim 11 wherein the snoop filter tracks each memory request within the coherent system fabric and generates snoop requests and the configurable snoop filter and bloom filter operating in one of: line-based inclusive snoop filtering, line-based non-inclusive snoop filtering, region based non-inclusive snoop filtering, region-based non-inclusive snoop filtering with bloom filtering, and bloom filtering.

13. The system of claim 11 wherein the snoop filter directory comprises a memory organized in set-associative ways where each entry of the way contains one or more valid bits, agent status bits, and tag field.

14. The system of claim 11 wherein the bloom filter comprise one hash table for each caching agent where each entry of the has tables is a counter, and the bloom filter further uses a hash function to generate keys based on the request address.

15. The system of claim 14 wherein the counters are used to save statistical information about a number of times that a key address has been generated.

16. The system of claim 15 wherein the bloom filter generates snoop requests based on the number of times that a key address has been generated.

17. The system of claim 11 wherein the write back policy of the coherent system fabric is configurable at run time.

18. The system of claim 11 wherein inclusive or non-inclusive mode is configurable at run time.

19. The system of claim 11 wherein enabling/disabling of the snoop filter is configurable at run time.

20. The system of claim 11 wherein enabling/disabling of the bloom filter is configurable at run time.

21. An apparatus comprising:
one or more processing cores;
an interconnect fabric coupled to the one or more processing cores, the interconnect fabric to include a snoop filter that is capable,
in a first mode of operation, to maintain an inclusive snoop filter directory and to filter snoops on a cache line granularity, and
in a second mode of operation, to maintain a non-inclusive snoop filter directory and to filter snoops on a cache line granularity.

22. The apparatus of claim 21 wherein, in a third mode of operation, the snoop filter to maintain a non-inclusive directory to filter snoops on a cache region granularity.

23. The apparatus of claim 21 wherein the snoop filter is configured based on workload, the configurable snoop filter having a configurable snoop filter directory and a bloom filter, the configurable snoop filter and the bloom filter include runtime configuration parameters that are used to selectively limit snoop traffic.

24. The apparatus of claim 23 wherein the bloom filter comprise one hash table for each caching agent where each entry of the has tables is a counter, and the bloom filter further uses a hash function to generate keys based on the request address.

25. The apparatus of claim 24 wherein the counters are used to save statistical information about a number of times that a key address has been generated.

26. The system of claim 25 wherein the bloom filter generates snoop requests based on the number of times that a key address has been generated.

27. The system of claim 21 wherein the write back policy of the coherent system fabric is configurable at run time.

28. The system of claim 21 wherein the snoop filter directory comprises a memory organized in set-associative ways where each entry of the way contains one or more valid bits, agent status bits, and tag field.

29. A non-transitory computer readable medium holding code, when executed, to cause a machine to perform the operations of:
in a coherent system fabric to couple a memory system with the one or more processing cores, the coherent system fabric comprising at least a configurable snoop filter to be configured based on workload, the configurable snoop filter having bloom filter logic and storage to hold a configurable snoop filter directory, configuring the snoop filter in one of a plurality of modes in a first mode of operation, to maintain an inclusive snoop filter directory and to filter snoops on a cache line granularity, in a second mode of operation, to maintain a non-inclusive snoop filter directory and to filter snoops on a cache line granularity.

30. The medium claim 29 wherein, in a third mode of operation, the snoop filter to maintain a non-inclusive directory to filter snoops on a cache region granularity.

31. The medium of claim 30 wherein the snoop filter is configured based on workload, the configurable snoop filter having a configurable snoop filter directory and a bloom filter, the configurable snoop filter and the bloom filter include runtime configuration parameters that are used to selectively limit snoop traffic.

32. The medium of claim 31 wherein the bloom filter comprise one hash table for each caching agent where each entry of the has tables is a counter, and the bloom filter further uses a hash function to generate keys based on the request address.
